(19) United States
(12) Patent Application Publication
(10) Pub. No.: US 2026/0132658 A1
(43) Pub. Date: May 14, 2026

(54) DOOR HANDLE

(71) Applicant: MINEBEA ACCESSSOLUTIONS ITALIA S.P.A., Pianezza (IT)

(72) Inventor: David PEDROLETTI, PIANEZZA (IT)

(73) Assignee: MINEBEA ACCESSSOLUTIONS ITALIA S.P.A., Pianezza (IT)

(21) Appl. No.: 19/379,214

(22) Filed: Nov. 4, 2025

(30) Foreign Application Priority Data
Nov. 12, 2024 (EP) 24212515.1

(51) Int. Cl. E05B 79/06

(52) U.S. Cl. CPC E05B 79/06

(57) ABSTRACT

A door handle includes a first part and a second part configured to be assembled together in an assembled state. The first part includes a mounting side mounted on a side of the second part, a first hook and a prefixation book both protruding from the mounting side. The first hook is, in a pre-assembled state of the first and second parts, configured to engage a corresponding member on the side of the second part. The prefixation hook is, in the pre-assembled state of the first and second parts, configured to engage a clipping member protruding the side of the second part, so that in the pre-assembled state of the first and second parts, the corresponding member and the clipping member maintain the mounting side of the first part in contact with the side of the second part, and prevent the first part from falling apart from the second part.

### CROSS-REFERENCE TO RELATED APPLICATIONS

This application claims priority to and the benefit of EP 24212515.1 filed on Nov. 12, 2024, the disclosure of which is incorporated herein by reference.

### FIELD

The present disclosure relates to the field of vehicle door handles.

### BACKGROUND

The statements in this section merely provide background information related to the present disclosure and may not constitute prior art.

It is known to have two parts assembled to provide a vehicle door with a vehicle door handle, a first part being usually installed inside a recess in the door sheet, on an external side of the door and accessible to a user opening the door, a second part being installed inside an internal part of the door. The assembly of the two parts is usually done with screws placed on the side or the internal part of the door.

The issue related to the assembly of the two parts is that it requires the presence of two operators: a first operator must hold the first part in position on the external side of the door, while a second operator activates a fixing member generally placed on the internal side of the door.

To maintain the first part in position, while a single operator is activating the fixing member, it is known to use a set of pre-fixing clips installed on the door sheet in the internal area of the handle opening. But this set of pre-fixing clips is dependent on the geometry of the door, and therefore on a supplier who is different from the supplier of the handle, so that the supplier of the handle cannot guarantee the assembly operation which requires very restricted tolerances to be able to function.

Therefore, there is a need to guarantee a pre-fixing operation independently of the conformity and tolerances of the door, by allowing the supplier of the handle to have total control of the two interfaces, on the first part side and on the second part side.

Once the first part is pre-fixed, it has then to be definitively fixed. It is known to use a slider part on the second part, which is activated by using a screw, and optionally a screwdriver. This may lead to relatively long assembly time. It is also known to use an eccentric cam to push the slider part, but said eccentric cam cannot pull the slider back to remove the handle.

Therefore, there is a further need to simplify the process to fix definitively the first part and the second part, so that the slider may be operated quickly, without having to use a screwdriver, and in both directions, which allows assembly and disassembly to be carried out. Thus, reliability of e-release switch will be improved.

### SUMMARY

This section provides a general summary of the disclosure and is not a comprehensive disclosure of its full scope or all of its features.

To that end, the present invention provides a door handle comprising a first part and a second part configured to be assembled together in an assembled state, wherein a mounting side of the first part is mounted on a side of the second part, the first part comprising a first hook protruding from said mounting side of the first part, the first hook being, in a pre-assembled state of the first part and the second part, configured to engage a corresponding member on the side of the second part, the first part comprising a prefixation hook protruding from said mounting side of the first part, said prefixation hook being, in the pre-assembled state of the first part and the second part, configured to engage a clipping member protruding the side of the second part, so that in the pre-assembled state of the first part and the second part, the corresponding member and the clipping member maintain the mounting side of the first part in contact with the side of the second part, and prevent the first part from falling apart from the second part.

According to these provisions, the operator is not obliged to manually maintain the first part during the assembly operation, in particular during a second part of the assembly operation wherein a slider is operated on another side of the second part, opposite to the side on which the first part is mounted, i.e. on an internal side of the door, i.e. internal to the vehicle.

According to an embodiment, the invention comprises one or more of the following features, alone or in any combination technically compatible.

According to an embodiment, the first part comprises one or more first hook(s), and one or more corresponding member(s).

According to an embodiment, the side of the second part comprises a hole, the corresponding member on the side of the second part being a rim of said hole, so that in the pre-assembled state of the first part and the second part, the first hook is inserted in the hole to engage the rim of said hole on the side of the second part.

According to an embodiment, the second part comprises a sliding part, slidingly attached to another side of the second part, the sliding part comprising at least one boss protruding transversally to an extension of the other side of the second part, and wherein the first part comprises at least one third hook protruding from the mounting side of the first part, the at least one third hook being, in the pre-assembled state of the first part and the second part, configured to pass through a hole in the side of the second part, the sliding part being moveable from a first position, wherein the at least one boss is free, to a second position wherein the at least one boss is inserted between the other side of the second part and the at least one third hook of the first part, so that the at least one third hook being pulled towards the second part by the at least one boss, the first part is assembled to the second part.

According to an embodiment, the second part further comprises a driving part, said driving part being configured to drive the sliding part from the first position of the sliding part to the second position of the sliding part.

According to an embodiment, the sliding part comprises a driving hole, wherein said driving part comprises a driving member protruding transversally to an extension of the sliding part through the driving hole of the sliding part, the driving member being excentered with respect to an axis of rotation of the driving part mobile in rotation between a first position of the driving part wherein the driving member drives the sliding part to the first position of the sliding part and a second position of the driving part wherein the driving member drives the sliding part to the second position of the sliding part.

According to these provisions, the sliding part is translated from it first position to the second position, i.e. wherein the first part is fully assembled with the second part, by making only a quarter turn using only one tool from the internal side of the second part. Moreover, these provisions enable a reverse translation of the sliding part from the second position to the first position, to disassemble the two parts if necessary. Thus these provisions allow very rapid and simple assembly, and diassembly, of the two parts of the handle.

According to an embodiment, the driving hole of the sliding part is provided with at least two driving walls, so that the driving member leans on one driving wall to drive the sliding part from the first position to the second position, and the driving member leans on another driving wall to drive the sliding part from the second position to the first position.

According to an embodiment, the driving part is provided with a first notch configured to engage a locking member of the second part in the first position of the sliding part, and with a second notch configured to engage the locking member of the second part in the second position of the sliding part.

According to these provisions, the notches and the locking member ensures that the driving part and the sliding part are held in appropriate position.

According to an embodiment, the driving part is provided with rotation tracks on a surface of the driving part in sliding contact with a corresponding surface of the second part, said rotation tracks being configured to guide the rotation of the of the driving part on the corresponding surface of the second part.

According to an embodiment, the driving part is provided with a fixation clip configured to rotatively mount the driving part on the second part.

According to another aspect, the invention provides a vehicle door comprising a door handle according to anyone of the embodiments described hereinabove, wherein the first part is installed on a side of the door outside of the vehicle, and wherein the second part is installed on a side of the door inside the vehicle.

According to an embodiment, the mounting side of the first part is concave, and the opposite side convex, the first part being installed inside a recess of the external door sheet, so that a user may use the convex side to open the door.

According to another aspect, the invention provides a vehicle comprising a vehicle door according to anyone of the embodiments described hereinabove.

Further areas of applicability will become apparent from the description provided herein. It should be understood that the description and specific examples are intended for purposes of illustration only and are not intended to limit the scope of the present disclosure.

### DRAWINGS

The foregoing and other purposes, features, aspects and advantages of the invention will become apparent from the following detailed description of embodiments, given by way of illustration and not limitation with reference to the accompanying drawings, in which the same reference refer to similar elements or to elements having similar functions, and in which:

FIG. 1 represents perspective view of a door handle according to an example embodiment of the disclosure, comprising an external part configured to be installed in a recess on an external side of the door (not represented on the figure), and an internal part installed on an internal side of the door;

FIG. 2 represents cross-sectional view of the door handle of FIG. 1 mounted on the vehicle door;

FIG. 3 represents another perspective and cross-sectional view of the door handle of FIG. 1 mounted on the vehicle door, focused on the pre-fixing clip according to an example;

FIG. 4a is a perspective rear view of the internal side of the second part according to an example realization, with the sliding part in a first position, corresponding to a pre-assembly of the door handle;

FIG. 4b is a view similar to FIG. 4a, with the sliding part in a second position, corresponding to a full assembly of the door handle;

FIG. 5 represents a perspective rear view of the internal side of the second part according to an example realization focusing on the driving part rotatively mounted on the second part;

FIG. 6 represents a perspective view of the sliding part according to an example realization; and

FIG. 7 represents a perspective view of the driving part according to an example realization.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

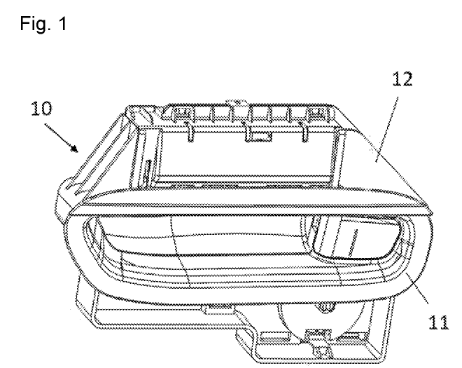

The invention relates to a door handle 10 which comprises two parts, 11, 12, assembled together such as illustrated in FIG. 1. Each of the two parts 11, 12 may be a sub-assembly comprising one or more sub-parts.

The door may be a vehicle door, and the first part 11 is for example installed on a side of the door outside of the vehicle, and the second part 12 may be installed on a side of the door inside the vehicle, for example in the internal part of the door. For example, the first part 11 may have the form of a bowl, and may be installed inside a recess of the external door sheet, so that a user may use the convex side of said bowl to open the door.

The first part 11 is configured to be fixed to the second part 12 in two steps : in a first step, a mounting side of the first part 11 is positioned, by one operator, in contact with a side of the second part 12, so that hooks 115, 115’, 113 of the first part 11 engage corresponding members 125, 125’, 123 of the second part 12, and so that the two parts 11, 12 are pre-assembled, enabling the operator to complete the next step of the assembly operation hands free; the first part 11 will remain in place in its pre-assembled position, while the operator reaches the internal side of the door to carry out the final step of the assembly operation.

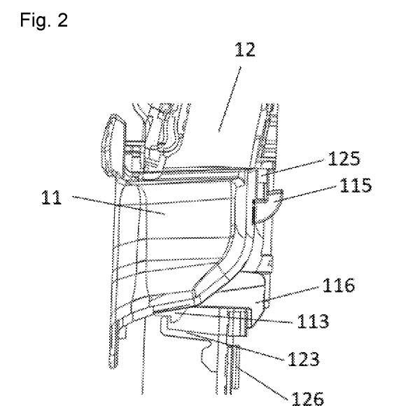

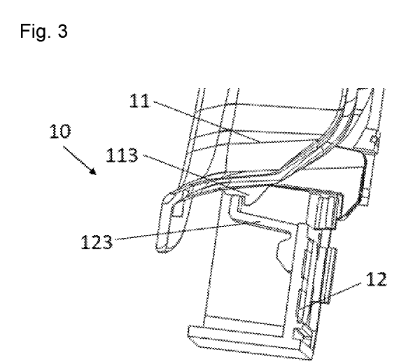

To that end, as illustrated in FIGS. 2 and 3, the first part 11 comprises at least one first hook 115, for example two first hooks 115, 115’, each of the first hooks protruding from the mounting side of the first part 11, the first hooks 115, 115’ being, in the pre-assembled state of the first part 11 and the second part 12, configured to engage a corresponding member 125, 125’ on the side of the second part 12 which is in contact with the mounting side of the first part 11.

Furthermore, the first part 11 comprises a prefixation hook 113 protruding from said mounting side of the first part 11, said prefixation hook 113 being, in the pre-assembled state of the first part 11 and the second part 12, configured to engage a clipping member 123 protruding from the side of the second part 12. In order for the prefixation hook 113 to engage said clipping member 123, the operator pushes the first part 11 in the direction of the side of the second part 12, down to the clipping point of the clipping member 123. Then the two parts 11, 12 are in a preassembled state, in which the corresponding member 125 and the clipping member 123 maintain the mounting side of the first part 11 in contact with the side of the second part 12, and prevent the first part 11 from falling apart from the second part 12.

According to these provisions, the operator is not obliged to manually maintain the first part 11 during the final step of the assembly operation, wherein a slider 126 is operated on another side of the second part 12, opposite to the side on which the first part 11 is mounted, for example on an internal side of the door, i.e. internal to the vehicle.

As an example, the corresponding members 125, 125’ of the hooks 115, 115’ result from holes traversing the side of the second part 12, so that when the hook 115, 115’ is inserted inside said hole, it engages a rim of the hole.

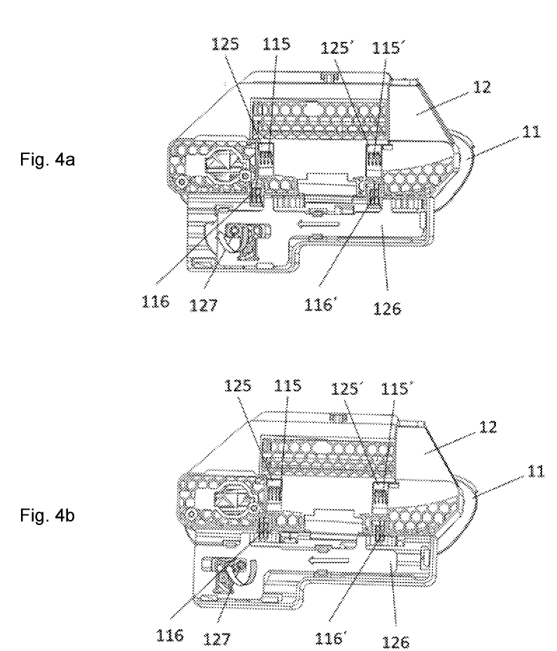

Optionally, the second part 12 comprises a sliding part 126, which is slidingly attached to another side of the second part 12, opposite to the side in contact with the mounting side of the first part 11, as illustrated in FIGS. 4a and 4b.

An example of the sliding part 126 is represented in FIG. 6. Optionally, the sliding part 126 is made of steel, to improve the resistance of the assembly.

The sliding part 126 comprises at least one boss 1261, 1261’, protruding transversally to an extension of the other side of the second part 12. The first part 11 comprises at least one third hook 116, 116’, for example two third hooks 116, 116’, protruding from the mounting side of the first part 11, and being, in the pre-assembled state of the first part 11 and the second part 12, configured to pass through a hole in the side of the second part 12.

As is illustrated in FIGS. 4a and 4b, the sliding part 126 is sliding, on a surface of the other side of the second part 12, from a first position, represented in FIG. 4a, wherein the at least one boss 1261, 1261’ is free, to a second position, represented in FIG. 4b, wherein the at least one boss 1261, 1261’ is inserted between the other side of the second part 12 and the at least one third hook 116, 116’ of the first part 11, so that the at least one third hook 116, 116’ is pulled towards the second part 12 by the at least one boss 1261, 1261’, and the first part 11 is definitevely assembled to the second part 12.

For example, to actuate the sliding translation of the sliding part 126, the second part 12 further comprises a driving part 127, said driving part 127 being configured to drive the sliding part 126 from the first position of the sliding part 126 to the second position of the sliding part 126.

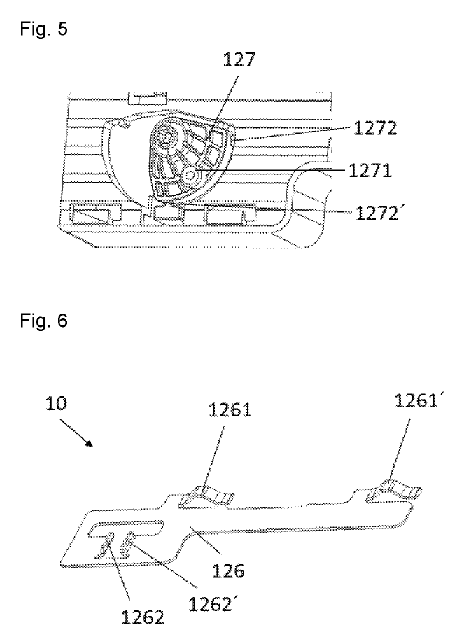

In particular, as illustrated in FIG. 5, said driving part 127 comprises a driving member 1271 protruding transversally to a planar extension of the sliding part 126 through a driving hole of the sliding part 126, the driving member 1271 being excentered with respect to an axis of rotation of the driving part 127. The driving part is mobile in rotation between a first position of the driving part 127, represented in FIG. 4a, wherein the driving member 1271 drives the sliding part 126 to the first position of the sliding part 126, and a second position of the driving part 127, represented in FIG. 4b, wherein the driving member 1271 drives the sliding part 126 to the second position of the sliding part 126.

According to these provisions, the sliding part 126 is translated from it first position to the second position, i.e. wherein the first part 11 is fully assembled with the second part 12, by making only a quarter turn, using only one tool, from the internal side of the second part 12. Moreover, these provisions enable a reverse translation of the sliding part 126 from the second position to the first position, to disassemble the two parts 11, 12 if necessary. Thus these provisions allow very rapid and simple assembly, and diassembly, of the two parts 11, 12 of the door handle according to the disclosure.

More particularly, the driving hole of the sliding part 126 is provided with at least two driving walls 1262, 1262’, as illustrated in FIG. 6, so that the driving member 1271 leans on one driving wall 1262 to drive the sliding part 126 from the first position to the second position, and the driving member 1271 leans on another driving wall 1262’ to drive the sliding part from the second position to the first position.

More particularly, the driving part 127 is provided with a first notch 1272’ configured to engage a locking member 128 of the second part 12 in the first position of the sliding part 126, and with a second notch 1272 configured to engage the locking member 128 of the second part 12 in the second position of the sliding part 126.

According to these provisions, the notches and the locking member ensures that the driving part and the sliding part are held in appropriate position.

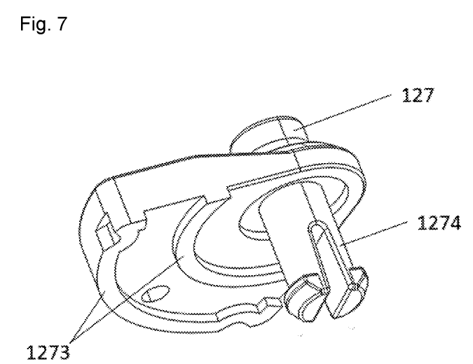

Optionally, as illustrated in FIG. 7, the driving part 127 is provided with rotation tracks 1273 on a surface of the driving part 127 in sliding contact with a corresponding surface of the second part 12, said rotation tracks 1273 being configured to guide the rotation of the of the driving part 127 on the corresponding surface of the second part 12. The driving part 127 may further be provided with a fixation clip 1274 configured to rotatively mount the driving part 127 on the second part 12.

According to an aspect, the dicosure further relates to a vehicle comprising a vehicle door provided with a door handle according to the examples described herein above.

Unless otherwise expressly indicated herein, all numerical values indicating mechanical/thermal properties, compositional percentages, dimensions and/or tolerances, or other characteristics are to be understood as modified by the word “about” or "approximately" in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A door handle comprising:
a first part and a second part configured to be assembled together in an assembled state, the first part including:
a mounting side mounted on a side of the second part,
a first hook protruding from the mounting side of the first part, the first hook being, in a pre-assembled state of the first part and the second part, configured to engage a corresponding member on the side of the second part, and
a prefixation hook protruding from the mounting side of the first part, said prefixation hook being, in the pre-assembled state of the first part and the second part, configured to engage a clipping member protruding the side of the second part, so that in the pre-assembled state of the first part and the second part, the corresponding member and the clipping member maintain the mounting side of the first part in contact with the side of the second part, and prevent the first part from falling apart from the second part.

2. The door handle according to claim 1, wherein the side of the second part comprises a hole, the corresponding member on the side of the second part being a rim of said hole, so that in the pre-assembled state of the first part and the second part, the first hook is inserted in the hole to engage the rim of said hole on the side of the second part.

3. The door handle according to claim 1, wherein the second part comprises a sliding part, slidingly attached to another side of the second part, the sliding part comprising at least one boss protruding transversally to an extension of the other side of the second part, and wherein the first part comprises at least one third hook protruding from the mounting side of the first part, the at least one third hook being, in the pre-assembled state of the first part and the second part, configured to pass through a hole in the side of the second part, the sliding part being moveable from a first position, wherein the at least one boss is free, to a second position wherein the at least one boss is inserted between the other side of the second part and the at least one third hook of the first part, so that the at least one third hook being pulled towards the second part by the at least one boss, the first part is assembled to the second part.

4. The door handle according to claim 3, wherein the second part further comprises a driving part, said driving part being configured to drive the sliding part from the first position of the sliding part to the second position of the sliding part.

5. The door handle according to claim 4, wherein the sliding part comprises a driving hole, wherein said driving part comprises a driving member protruding transversally to an extension of the sliding part through the driving hole of the sliding part, the driving member being excentered with respect to an axis of rotation of the driving part mobile in rotation between a first position of the driving part wherein the driving member drives the sliding part to the first position of the sliding part and a second position of the driving part wherein the driving member drives the sliding part to the second position of the sliding part.

6. The door handle according to claim 5, wherein the driving hole of the sliding part is provided with at least two driving walls, so that the driving member leans on one driving wall to drive the sliding part from the first position to the second position, and the driving member leans on another driving wall to drive the sliding part from the second position to the first position.

7. The door handle according to claim 4, wherein the driving part is provided with a first notch configured to engage a locking member of the second part in the first position of the sliding part, and with a second notch configured to engage the locking member of the second part in the second position of the sliding part.

8. The door handle according to claim 4, wherein the driving part is provided with rotation tracks on a surface of the driving part in sliding contact with a corresponding surface of the second part, said rotation tracks being configured to guide the rotation of the driving part on the corresponding surface of the second part.

9. The door handle according to claim 4, wherein the driving part is provided with a fixation clip configured to rotatively mount the driving part on the second part.

10. A vehicle door comprising the door handle according to claim 1, wherein the first part is installed on a side of the vehicle door outside of a vehicle, and wherein the second part is installed on a side of the vehicle door inside the vehicle.

11. The vehicle door according to claim 10, wherein the mounting side of the first part is concave, and the opposite side convex, the first part being installed inside a recess of an external door sheet, so that a user may use the convex side to open the door.

12. A vehicle comprising:
a vehicle door comprising the door handle according to claim 1,
wherein the first part is installed on a side of the vehicle door outside of a vehicle, and wherein the second part is installed on a side of the vehicle door inside the vehicle.
